(19) United States
(12) Patent Application Publication
(10) Pub. No.: US 2022/0223072 A1
(43) Pub. Date: Jul. 14, 2022

(54) Multi-Display Apparatus And Methods of Use

(71) Applicant: Balloon Innovations, Inc., Westminster, CO (US)

(72) Inventors: Christopher J. Wicken, Golden, CO (US); Alex J. Fountain, Evergreen, CO (US)

(21) Appl. No.: 17/570,801

(22) Filed: Jan. 7, 2022

Related U.S. Application Data
(60) Provisional application No. 63/136,384, filed on Jan. 12, 2021.

(51) Int. Cl. G09F 7/18; G09F 17/00; G09F 19/00

(52) U.S. Cl. CPC G09F 7/18; G09F 17/00; G09F 2007/1804; G09F 2017/0066; G09F 19/008

(57) ABSTRACT

The current inventive technology includes methods and apparatus for a multi-display system and methods of use thereof. In one embodiment, the present invention includes a multi-display coupler that may be used to support a plurality of displays, such as a helium-free balloons.

### CROSS REFERENCES TO RELATED APPLICATION

This application claims the benefit of and priority to U.S. Provisional Application No. 63/136,384, filed Jan. 12, 2021. The entire specification and figures of the above-referenced application is hereby incorporated in its entirety by reference.

### TECHNICAL FIELD

This invention described herein relates to a novel multi-display apparatus configured to be used for outdoor or indoor marketing displays. In one preferred embodiment, the novel multi-display apparatus may be particularly adapted to display one or more helium-free balloons in a unique clustered configuration. The balloon system can be attached to a vehicle, mounted on the top of an outside ground surface, mounted on top of a show room floor, and suspended from a wall and like applications.

### BACKGROUND

Traditional marketing displays, such as flags, banners, signs, and balloons are often placed in, or near commercial establishments to draw customer attention. Such displays are generally positioned in elevated positions to both generate a clear line of sight to potential consumers, as well as to make use of generally empty space thus maximizing the display's commercial impact without impeding the flow of consumers. Such traditional marketing displays, such as signage, flags, balloons, and even artistic presentations are often secured in elevated positions through simple supports, or simply being manually secured to existing structures. However, such traditional displays may be difficult to position in certain geometric or other configurations and are often difficult to set up or break down limiting their initial use, as well as future re-use. As can be seen, there exist a need for a simple, reusable, and modular system to quickly construct and de-construct marketing displays in unique and eye-catching configurations.

### SUMMARY OF THE INVENTION

In one aspect, the invention generally relates to a modular multi-display system that may be used to generate customizable geometric clusters and displays that may be used for marketing, promotional, advertising, and decorative displays, among others. In one aspect, the invention include systems and methods for a display apparatus that may be modular in natures such that it may easily set up and broken down and further positioned indoor, outdoors or in any location that may attract the attention of a consumer. In preferred aspect, the display apparatus may include a multi-display coupler having a plurality of display attachments that may secure one or more displays, such as flags, banners, signage, and preferably helium-free balloons.

As noted above, in one preferred embodiment, the display may include a helium-free balloon. In this embodiment, such a helium-free balloon may be generally described in U.S. Pat. No. 9,352,240, and include an inflatable, re-inflatable and reusable heavy duty, seamless helium-free balloon made from, for example a thermoplastic or other similar material.

In another aspect, the multi-display coupler may include a plurality of support arm having one or more display attachments, and a corresponding number of coupler recesses. In this configuration, multiple multi-display couplers may be position along a mounting pole and further secure one or more display, which may preferably be coupled with a flexible rod. In this configuration, the flexible rods supporting a display may be positioned in an upward projection and may be positioned with the coupler recess of a second multi-display coupler positioned above a first multi-display coupler. In this configuration, a plurality of multi-display couplers may be positioned along the length of a mounting pole and secure a plurality of displays, such that said upwardly projecting flexible rods may be intermeshed or secured with the adjacent multi-display coupler with another to form a closely adjacent display cluster.

In another aspect, the invention includes systems and methods for a multi-display apparatus. In this preferred aspect, a plurality of displays may be coupled with a supported mounting pole through one or more multi-display coupler having a plurality of display attachments that may secure one or more displays, such as flags, banners, signage, and preferably helium-free balloons. In this preferred aspect, the displays may be positioned in an upward orientation compared to the length of the with the mounting pole, which may further secure one or more additional displays secured to the distal, or top portion of said mounting pole, for example, through a pole coupler.

In another aspect, the in the invention include systems and methods for a multi-balloon cluster display having a plurality of helium-free balloon display clusters coupled along the length of a mounting pole and a helium-free balloon top display cluster positioned to the distal portion of the mounting pole forming a balloon cluster in a clustered orientation. Additional aspect may include a multi-display cluster apparatus having a plurality of display clusters coupled along the length of a mounting pole and a top display cluster positioned to the distal portion of the mounting pole forming a display cluster in a clustered orientation.

Additional aspects of the present invention will become apparent through the detailed explanation below.

### BRIEF DESCRIPTION OF FIGURES

FIG. 1: shows a multi-display coupler having a plurality of support arms each having a display attachment configured to secure at least one flexible rod in one embodiment thereof.

FIG. 2: (A) shows a blow-up view of multi-display coupler in one embodiment thereof; (B) shown a plurality of helium-free balloon displays coupled with flexible rods through a display coupler positioned in an upward projected configuration in one embodiment thereof; (C) shows a blow-up view of plurality of multi-display couplers securing five separate displays, in this embodiment being helium-free balloons forming a display cluster, a mounting pole and a top display cluster, wherein the helium-free balloons are positioned in an upward projected configuration forming the exemplary multi-balloon cluster display in (D) in one embodiment thereof.

FIG. 3: (A) shows a top view of a multi-display coupler having a pole aperture and slide position in one embodiment thereof; (B) shows a side-view of a multi-display coupler having a plurality of support arms each having a display attachment configured to secure at least one flexible rod in one embodiment thereof; (C) shows an alternative side-view of a multi-display coupler having a plurality of support arms each having a display attachment configured to secure at least one flexible rod in one embodiment thereof; (D) shows a perspective-view of a multi-display coupler having a plurality of support arms each having a display attachment configured to secure at least one flexible rod in one embodiment thereof.

FIG. 4: shows an exemplary multi-balloon cluster display having a plurality of multi-display coupler supporting a plurality of helium-free balloon displays positioned in an upward projected position and a top display cluster secured to the distal end of a mounting pole supported by a support in one embodiment thereof.

### DETAILED DESCRIPTION OF THE INVENTION

The present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

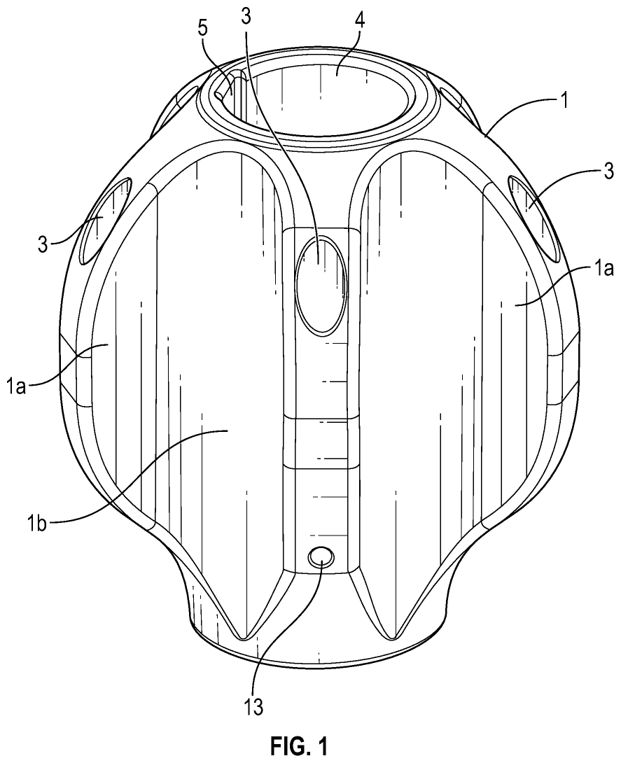

The invention may include a modular display apparatus that be configured to be quickly set-up, customized in its appearance, and positioned outside or inside a commercial establishment or social event so as to capture consumer interest. In this preferred embodiment, the display apparatus of the invention may include a multi-display coupler (1). As shown in FIG. 1, a multi-display coupler (1) may be formed of a unitary components, and preferably made from a material such as a hard plastic or the like and may further include a plurality of display attachments (3). In one embodiment, a display attachments (3) may include a fitted slot on a multi-display coupler (1) configured to insert and secure a display, and more preferably, a display rod (10).

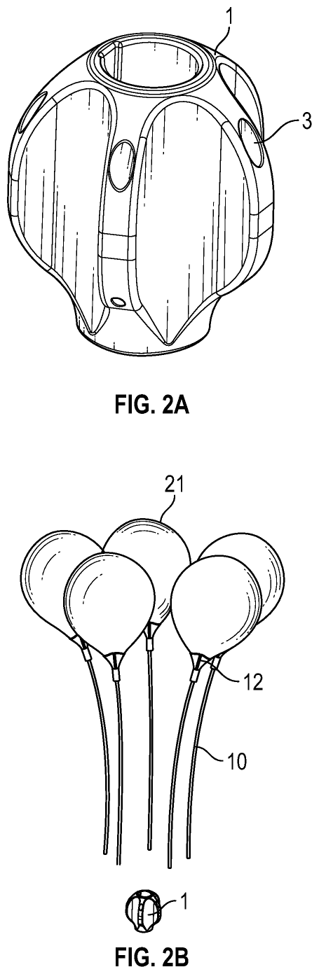

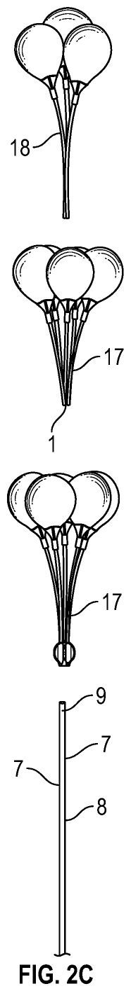

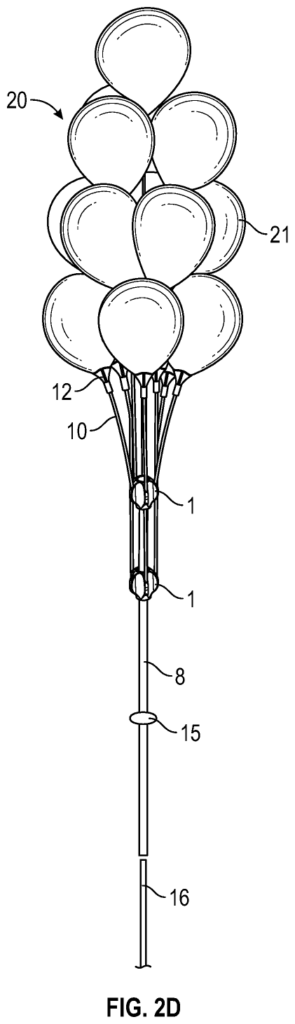

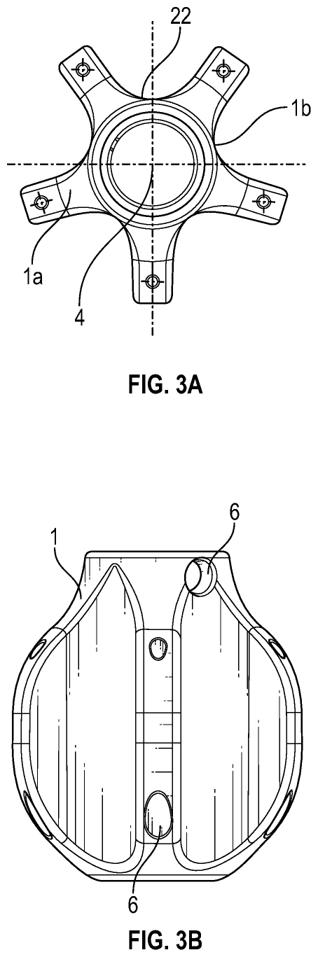

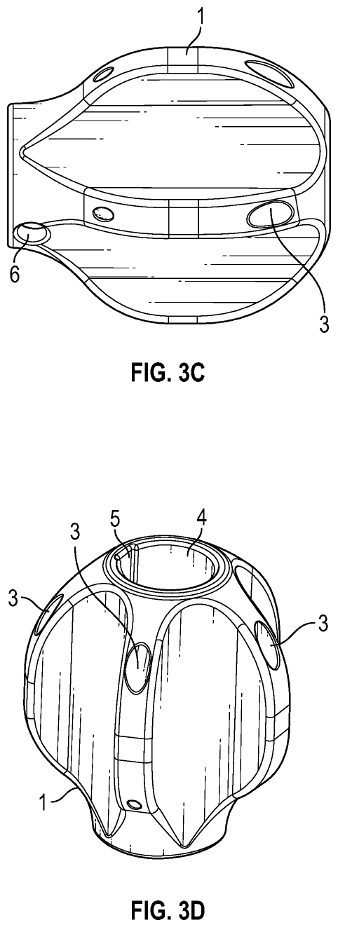

As shown in the embodiment of FIG. 2B-D, a display, in this embodiment being a helium-free balloon (21) may be coupled with a display rod (10) through a display coupler (12) and the proximal portion of the display rod (10) may be inserted into the display attachment (3). Again, as shown in FIG. 2D, in this configuration, a sufficient portion of the display rod (10) is positioned with the display attachment (3) such that the rod (10) is secured in an upward position. In this example, a multi-display coupler (1) has five display attachments (3) around its circumference with display attachment (3) being configured to secure at least one display rod (10) in an upward position. In the preferred embodiment shown in the figures the display attachment (3) may include a slot configured to hold a corresponding display rod (10), however additional embodiment may include a display attachment (3) having a coupler component, such as a twist coupler, a snap coupler, a spring coupler, and a quick coupler. In this embodiment, a display rod (10) may be coupled with a display attachment (3) of the multi-display coupler (1), for example through a twist coupler having one or more projections on the display rod (10) that may be mated and coupled with a twist coupler position on the multi-display coupler (1).

Notably, while in the embodiment shown in the figures the display attachments (3) of the invention are positioned on the multi-display coupler (1) such that a corresponding display rod (10) is secured in an upward position, this arrangement is exemplary only. For example, in alternative embodiment, display attachments (3) of the invention are positioned on the multi-display coupler (1) such that a corresponding display rod (10) may be orientated in a plurality of positions, such as horizontally or at an angle, or even downward. In certain embodiments, the multi-display coupler (1) of the invention may include a plurality of differently orientated display attachments (3) such that a user can customize the type and arrangement of the display coupled to the coupler (1). It should also be noted, that while in one embodiment the display attachments (3) of the invention may be coupled with a display rod (10) supporting a display, such as a helium-free balloon (21), in alternative embodiments a display attachment (3) may directly be coupled with a display or display coupler (12).

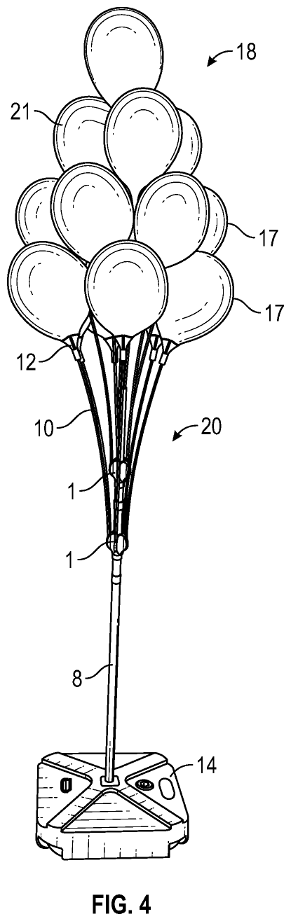

As shown in FIGS. 2 and 4, in a preferred embodiment the display rod (10) of the invention may include a semi-rigid or flexible display rod, such as a fiberglass display rod, an overmolded fiberglass rod, or a plastic rod. In this embodiment, the flexible display rod may have sufficient rigidity to support the corresponding display but be flexible such that they may allow for flexing and adjustment, for example as shown in FIG. 4 when forming a cluster design of helium-free balloons requiring an outward bending of the display rods to accommodate the overlapping balloon structures.

As noted above, while a display of the invention generally encompasses a variety of advertising, marketing and other items, in preferred embodiment, multi-display coupler (1) of the invention may secure a display selected from the group consisting of: a helium-free balloon coupled with a flexible rod by a display coupler, a flag coupled with a flexible rod by a display coupler, a banner coupled with a flexible rod by a display coupler, a sign coupled with a flexible rod by a display coupler or a combination of the same. As noted above, in one preferred embodiment, the display may include a helium-free balloon. In this embodiment, such a helium-free balloon may be generally described in U.S. Pat. No. 9,352,240, and include an inflatable, re-inflatable and reusable heavy duty, seamless helium-free balloon made from, for example a thermoplastic or other similar material.

Referring now to FIG. 2D, a multi-display coupler (1) of the invention may be position along the length of a mounting pole (8). In this embodiment, a multi-display coupler (1) may include a pole aperture (4) configured to allowing a corresponding mounting pole (8) to be inserted through the aperture of the multi-display coupler (1). As further shown in FIG. 2D, in a multi-display coupler (1) may slide along the length of the mounting pole (8) and further secured to a desired position. In this configuration, the mounting pole (8) of the invention may include a locking component that may secure the multi-display coupler (1) at a desired position along the length of the mounting pole.

As shown in FIGS. 1 and 2C, in a preferred embodiment, a mounting pole (8) may include a spring lock (7) at a pre-determined position having a spring-biased extension extending horizontally from the mounting pole (8). In this configuration, a multi-display coupler (1) may include a slide (5) positioned along the internal surface of the pole aperture (4) that may be configured to slide over the now depressed extended extension of the spring lock (7). The multi-display coupler (1) may be positioned such that the extended extension of the spring lock (7) may be positioned over a lock aperture (6) and thereby allowing the extension to be extended and securing the multi-display coupler (1) along the length of the mounting pole (8). Notably, such an embodiment is exemplary only, as a variety of locking mechanisms and configurations may be used to secure a multi-display coupler (1) along the length of the mounting pole (8). For example, in one alternative embodiment, a multi-display coupler (1) may be hinged such that it can be opened and positioned at a desired position along the length of the mounting pole (8) and then closed forming a fitted joint. This fitted joint may be reinforced by a series or tighteners, such as screws, or tightening latches for example.

Alternative embodiments include a coupler device, such as a twist, click, spring biased, or quick connect coupler, configured to secure a multi-display coupler (1) along the length of the mounting pole (8). In still further embodiment, a mounting pole (8) may include a series of extensions extending from the mounting pole (8) that be positioned against and support the and multi-display coupler (1) along the length of the mounting pole (8).

In one preferred embodiment, a mounting pole (8), and corresponding display apparatus, may be coupled with pole support (14) that may secure the mounting pole (8) in an upright position. Generally referring to FIGS. 2D and 4, in one preferred embodiment a pole support (14) may include a weighted base having a slot to inert and secure the mounting pole (8). This weighted pole support (14) may be advantageous when a user desires to position the display apparatus on a cement or other hard surface.

In alternative embodiments, a mounting pole (8) may be configured to be secured in the ground. In this embodiment, the mounting pole (8) may include a spiked end that may be secured into the ground and may further include a support plate (15) positioned along the length of the mounting pole (8) preventing the mounting pole (8) from being extended into the ground beyond a desired point. In an alternative embodiment, a spike, support plate (15), may be positioned in the ground, and the pole, also optionally having a support plate (15) may be positioned over the spoke securing the display apparatus in the ground. Further embodiment may further include a separate spike or ground stake that may secure a mounting pole (8), for example through a coupler or other attachment. In still further embodiments, a self-adjusting support plate device, as described in U.S. Pat. No. 10,850,206, may be used to secure a mounting pole in the ground or other penetrable surface.

Generally referring to FIG. 2C, a display, in this embodiment a top display cluster having plurality of helium-free balloons (21) may be secured to the distal, or top portion of the mounting pole (8). In this preferred embodiment, a mounting pole (8) may include a pole coupler (9) that may be configured to secure one or more displays. As noted above, such a couple may include a fitted recess, as well as a coupler component, such as a twist, snap, quick connect, or slide coupler or a combination of the same.

Generally referring to FIGS. 2D and 4, the invention may include a multi-balloon cluster display formed by at least a first and second display clusters (17), and a top display cluster (18) coupled with a mounting pole (8). In this embodiment, a mounting pole (8) may secure a plurality of multi-display couplers (1) securing a plurality of helium-free balloon (21) displays in a clustered configuration. Specifically, as shown in FIG. 4, a mounting pole (8) may secure a first display clusters (17) having comprising a multi-display coupler (1) with a plurality of display attachment (3) wherein each display attachment (3) is configured to secure at least one display rod (10) or display, and further coupled with at least one helium-free balloon (21) display forming a plurality of helium-free balloons displays positioned in an upward projection. The mounting pole (8) further may secure a second display cluster (17) having a second multi-display coupler (1) secured to said pole above the multi-display coupler (1) and also having a plurality of display attachments (3) wherein each display attachment (3) is configured to secure at least one display rod (10), or display, further coupled with at least one helium-free balloon (21) display forming a plurality of helium-free balloon displays a plurality of helium-free balloon display.

The multi-balloon cluster display of the invention may further include a top display cluster (18) may be secured to the distal portion of the mounting pole (8). In this embodiment, a pole mount (9), positioned at the distal end of the mounting pole (8), may secure at least one display rod (10) further coupled with at least one helium-free balloon (21) or other display, wherein said helium-free balloon (21) or display project upward from said pole coupler and when positioned with the helium-free balloon (21) or displays coupled with the first or second multi-display couplers (1) forms a balloon cluster configuration as shown herein.

In one embodiment, the multi-display couplers (1) of the invention may include a plurality of support arms (1a) having one or more display attachments (3), and a series of coupler recess (1b) in between said arms (1a). As further shown in FIGS. 2 and 4, the first and second multi-display couplers (1) may be position along the length of said mounting pole (8) in an offset configuration such that said coupler recesses (1b) on said first and second display couplers are offset one from another and in line with the corresponding coupler arms (1a) of the other. In this embodiment, a flexible rod (1) securing a display, such as a helium-free balloon (21) is coupled with a first multi-display coupler (1) may be position in an upward orientation and be further positioned within the coupler recess (1b) of said second multi-display coupler (1) positioned above the first allowing said flexible rod to be meshed with the couplers and restrict their movement around the circumference of the mounting pole (8). This feature may allow a user to arrange the helium-free balloons (21) the clustered positions as shown herein.

In a preferred embodiment, a first and second display cluster (17) may include a first and second multi-display couplers comprise multi-display couplers (1) may include at least five display attachments (3) which may secure five display rods (10) each coupled with a helium-free balloon (21) through a diary coupler (12). As further shown, a top display cluster (18), in this preferred embodiment may include a pole coupler (9) securing three display rods (10) each coupled with a helium-free balloon (21) through a diary coupler (12). In this embodiment, thirteen helium-free balloons (21) may be secured to a mounting pole (8) in a clustered arrangement and presented to consumers as a display and commercial attractant.

Naturally, all embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves systems, methods, and techniques as well as devices to accomplish a display support system. In this application, the techniques, including novel and unique uses of manufacturing methods and materials, are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this provisional application is intended to serve as a basic description. The reader should be aware that the specific discussion may not explicitly describe all embodiments possible; many alternatives are implicit. It also may not fully explain the generic nature of the inventive technology and may not explicitly show how each feature or element can actually be representative of a broader function or of a great variety of alternative or equivalent elements. Again, these are implicitly included in this disclosure. Where the inventive technology is described in device-oriented terminology, each element of the device implicitly performs a function. Apparatus claims may not only be included for the device described, but also method or process claims may be included to address the functions the inventive technology and each element performs. Neither the description nor the terminology is intended to limit the scope of the claims that will be included in any subsequent patent application.

It should also be understood that a variety of changes may be made without departing from the essence of the inventive technology. Such changes are also implicitly included in the description. They still fall within the scope of this inventive technology. A broad disclosure encompassing both the explicit embodiment(s) shown, the great variety of implicit alternative embodiments, and the broad apparatus, methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the inventive technology both independently and as an overall system.

Further, each of the various elements of the inventive technology and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of an “coupler” should be understood to encompass disclosure of the act of “coupling”—whether explicitly discussed or not—and, conversely, were there effectively disclosure of the act of “coupling”, such a disclosure should be understood to encompass disclosure of an “coupling method and/or technique, and or device” and even a “means for coupling.” Such changes and alternative terms are to be understood to be explicitly included in the description.

Thus, the applicant(s) should be understood to have support to claim and make a statement of invention to at least: i) each of the methods, apparatus, improvements and/or devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 715 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the inventive technology, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A display apparatus comprising:
at least one multi-display coupler having a plurality of display attachments wherein each display attachment secures at least one display rod;
at least one display coupled with at least one of said display rods by a display coupler wherein;
a mounting pole secured to said multi-display coupler through at least one pole lock; and
at least one pole support coupled with said mounting pole.

2. The apparatus of claim 1, wherein said multi-display coupler comprises a multi-display coupler having a plurality of support arms having at least one display attachment, and a plurality of coupler recesses.

3. The apparatus of claim 2, wherein said multi-display coupler comprises a multi-display coupler having five display attachments.

4. The apparatus of claim 3, wherein said display attachment comprises a display attachment configured to secured to the proximal portion of a least one display rod such that said display is projected upward.

5. The apparatus of claim 1, wherein said display attachment comprises a display attachment selected from the group consisting of: a fitted slot, a twist coupler, a snap coupler, a spring coupler, and a quick coupler.

6-7. (canceled)

8. The apparatus of claim 1, wherein said display attachment comprises a coupler secured to a flexible display rod.

9. The apparatus any of claim 1, wherein said display comprises a display selected from the group consisting of: a helium-free balloon coupled with a flexible rod by a display coupler, a flag coupled with a flexible rod by a display coupler, a banner coupled with a flexible rod by a display coupler, a sign coupled with a flexible rod by a display coupler, or a combination of the same.

10-13. (canceled)

14. The apparatus any of claim 1, further comprising at least one display coupled with said mounting pole on the distal end of said mounting pole.

15. A multi-display apparatus comprising:
a multi-display coupler having a plurality of display attachments wherein each display attachment is secured to at least one display rod further coupled with at least one display;
a mounting pole securing said multi-display coupler through at least one pole lock;
one or more additional displays secured to at least one display rod and further coupled to the distal portion of said mounting pole; and
at least one pole support coupled with said mounting pole.

16. The multi-display apparatus of claim 15, wherein said multi-display coupler comprises a multi-display coupler having a plurality of support arms having at least one display attachment, and a plurality of coupler recesses.

17. The multi-display apparatus of claim 15, wherein said multi-display coupler comprises a multi-display coupler having five display attachments.

18. The multi-display apparatus of claim 15, wherein said display attachment comprises a display attachment secured to the proximal portion of a least one display rod such that said display is projected upward.

19. The multi-display apparatus of claim 15, wherein said display attachment comprises a display attachment selected from the group consisting of: a fitted slot; a twist coupler, a snap coupler, a spring coupler, and a quick coupler.

20-21. (canceled)

22. The multi-display apparatus of claim 15, wherein said display attachment comprises a coupler secured to a flexible display rod.

23. The multi-display apparatus of claim 15, wherein said display comprises a display selected from the group consisting of: a helium-free balloon coupled with a flexible rod by a display coupler, a flag coupled with a flexible rod by a display coupler, a banner coupled with a flexible rod by a display coupler, a sign coupled with a flexible rod by a display coupler or a combination of the same.

24-27. (canceled)

28. The multi-display apparatus of claim 15, further comprising a second multi-display coupler having a plurality of display attachments wherein each display attachment is secured to at least one display rod further coupled with at least one display.

29. The multi-display apparatus of claim 28, wherein said number of displays comprises between 3-13 displays.

30. The multi-display apparatus of claim 15, further comprising one or more additional displays secured to at least one display rod and further coupled to a pole mount positioned on the distal portion of said mounting pole.

31. A multi-display cluster comprising:
a mounting pole;
a first display cluster comprising:
first multi-display coupler secured to said pole, and having a plurality of display attachments wherein each display attachment is secured to at least one display rod further coupled with at least one display forming a plurality of displays projecting upward from said first multi-display coupler secured to said pole;
a second display cluster comprising:
second multi-display coupler secured to said pole, and having a plurality of display attachments wherein each display attachment is secured to at least one display rod further coupled with at least one display forming a plurality of displays projecting upward from said second multi-display coupler secured to said pole;
a top display cluster comprising:
a pole mount, positioned at the distal end of said mounting pole, and securing at least one display rod further coupled with at least one display wherein said displays project upward from said pole coupler; and
at least one pole support.

32-47. (canceled)

48. The multi-display cluster of claim 31, wherein said display comprises a a display selected from the group consisting of: a helium-free balloon, a flag, a banner, a sign, or a combination of the same.
